(19) United States
(12) Patent Application Publication
(10) Pub. No.: US 2004/0063529 A1
(43) Pub. Date: Apr. 1, 2004

(54) Guide system for tensioning a belt and a method of regulating belt tension

(76) Inventors: Phillippus Mare, Pretoria (ZA); Conrad Sevenster, Pretoria (ZA)

Correspondence Address: NIXON & VANDERHYE, PC, 1100 N GLEBE ROAD, 8TH FLOOR, ARLINGTON, VA, 22201-4714, US

(21) Appl. No.: 10/432,163

(22) PCT Filed: Nov. 20, 2001
(86) PCT No.: PCT/ZA01/00179

(30) Foreign Application Priority Data
Nov. 20, 2000 (ZA) 20006762
Nov. 20, 2000 (ZA) 20006723

(51) Int. Cl. F16H 7/22; F16H 7/08

(52) U.S. Cl. 474/109; 474/104; 474/102; 474/14

(57) ABSTRACT

The invention provides for a guide system (10) for tensioning a belt. The guide system (10) comprises an endless belt (12); at least two guides (14, 16) for guiding the belt (12); and tensioning means (18) for tensioning the belt (12) between the guides (14, 16), the tensioning means (18) being movable between a tensioned and a substantially non-tensioned position such that in the tensioned position it is biased to the non-tensioned position to compensate for a loss in belt tension. The guide system (10) also comprises self-adjusting regulating means that is operatively associated with the tensioning means (18) and that is adapted for moving the tensioning means (18) towards its tensioned position upon occurrence of belt slacking for effecting substantially immediate tensioning of the belt (12) while the belt (12) is running and without the necessity of manual intervention. The invention further includes a method of regulating belt tension of the belt (12) and for effecting tensioning of the belt (12) upon occurrence of belt slacking.

### TECHNICAL FIELD

This invention relates to a guide system. More particularly, the invention concerns a guide system adapted for tensioning a belt extending between adjacent guides of the guide system. The invention also includes a method of regulating belt tension of the belt and for effecting tensioning of the belt upon occurrence of belt slacking.

### BACKGROUND ART

Those who are familiar with the Industry will appreciate that mechanical power transmission systems for driving pumps, crushers, floatation cells and the like often comprise driving means, such as an electrical motor including a driver pulley, and driven means, such as a driven pulley that is connected to the pump, crusher, floatation cell or the like to be driven. The driver and driven pulleys are operatively associated with one another by means of at least one intermediate belt extending between the pulleys for transmitting mechanical power from the driver to the driven pulley. It is an essential requirement for proper working of the system that the belt remains tensioned between the pulleys.

A disadvantage generally associated with transmission systems incorporating a belt tensioned between adjacent pulleys is that the belt, which is often manufactured from rubber or the like material, tends to stretch in use, resulting in slacking of the belt. In addition, slacking of the belt occurs because of a change in power load for a particular driver pulley.

Once belt slacking occurs, there is non-optimal power transmission between the driver and driven pulleys. This results in ineffective functioning of the power transmission system as a whole. Particularly, slacking of the belt could result in partial displacement of the belt on either of the pulleys causing particularly the driver pulley to slip and grip in use. As a consequence hereof, frictional heat is generated at the driver pulley, which in turn heats the belt causing further rapid belt stretch. This not only Increases mechanical wear and tear of the pulleys and pulley bearings, but also reduces life span of the belt, thus resulting in increased maintenance and operating costs of the transmission system as a whole.

In an effort to overcome or minimize at least some of the above disadvantages, it has been known to pre-tension the belt to compensate for losses in belt tension resulting from stretching of the belt in use. One way of effecting such pre-tensioning is to mount the driver pulley to a base plate that is movable against the biasing action of a spring, for example. One type of spring that is known and often used in the industry for this type of application, is the so-called “Neidhart-unit”, which is a torsion element protected in terms of the so-called “Neidhart patent”. As the base plate is moved against the action of the spring, tension is put on the spring, the arrangement being such that the tension is gradually released either as the belt stretches or as the power load changes.

One disadvantage associated with known pre-tensioning methods and devices is that they provide no means for monitoring belt slacking. In use, belt slacking can only be detected either visually or audibly through a shrieking noise caused by slipping of the belt on a pulley. However, by the time belt slacking is detected in such a manner, often substantial damage to the pulleys, belts, pulley bearings or the like components has occurred already.

In addition, because of the current Inability to monitor the extent of belt slacking at any given moment, plant operators are required regularly to stop mechanical power transmission systems to inspect the same and to measure belt tension by means of a belt tension indicator, in order to determine whether belt slacking has occurred and whether the belt should be re-tensioned. Invariably, such random shutdowns of the transmission systems result in unwanted and sometimes even unnecessary downtimes and associated production losses.

### OBJECT OF THE INVENTION

It is therefore an object of the present invention to provide a novel guide system for tensioning a belt extending between adjacent guides that will overcome or minimize the disadvantages associated with known systems of this kind, or at least to provide a useful alternative to such systems.

It is a further object of the present invention to provide a method of regulating belt tension of the belt extending between adjacent guides of the guide system while the system is operational.

### DISCLOSURE OF THE INVENTION

According to the invention there is provided a guide system comprising an endless belt; at least two guides for guiding the belt; tensioning means for tensioning the belt between the guides, the tensioning means being movable between a tensioned and a substantially non-tensioned position, the arrangement being such that in the tensioned position it is biased to the non-tensioned position to compensate for a loss in belt tension; and self-adjusting regulating means operatively associated with the tensioning means and being adapted for moving the tensioning means towards its tensioned position upon occurrence of belt slacking for effecting substantially immediate tensioning of the belt.

For the purpose of this document “belt” will be interpreted to include any continuous band of material for transferring power from one member to another including, although not limited to, elongate elastic or rubber belts, ropes, chains or the like.

In one form of the invention, the belt may be tensioned through displacement of at least one guide relative to the other. The two guides may be characterised therein that one guide is a driver guide, while the other is a driven guide. In one form of the invention, the driver guide may be movable relative to the driven guide in order to tension the belt. The movable guide may be movable away from the other, substantially non-movable guide so as to increase distance between the respective guides. Alternatively, both guides may be movable relative to and away from each other for tensioning the belt.

The tensioning means may be movable between a tensioned and a substantially non-tensioned position such that in the tensioned position it is biased to the non-tensioned position for moving the guides. Particularly, when the tensioning means is in the tensioned position, the belt may optimally be tensioned between the guides, and when the tensioning means is in the substantially non-tensioned position, the belt may non-optimally be tensioned between the guides.

In one form of the invention, the tensioning means may be a conventional belt tensioner.

In another form of the invention the tensioning means may be resilient biasing means that is flexible between a tensioned and substantially non-tensioned position. The resiliently flexible biasing means may be any suitable spring, torsion element or the like, such as a Neidhart unit. It will be appreciated that the Neidhart unit is a torsion element comprising an elongate shaft trapped within a concentrically orientated elongate sleeve, together with a number of resiliently flexible elements located intermediate an outside of the shaft and an interior face of the sleeve. The shaft and the sleeve, which are generally of triangular or square cross-section, are longitudinally off-set relative to each other by approximately 60° (for triangular cross-section) or 45° (for square cross-section), thus defining either three or four elongate bores intermediate the shaft and the sleeve. The resiliently flexible elements, which are generally elongate rubber elements, are located in these bores, the arrangement being such that when the shaft is rotated about its longitudinal axis relative to the sleeve the elements are substantially resiliently deformed, thus creating rotational tension on the shaft in an opposite direction.

In yet another form of the invention, the tensioning means may be other mechanical tensioning means selected from a group including, although not limited to, a screw thread mechanism, at least one hydraulic tensioning arm, a worm gear arrangement or the like.

The self-adjusting regulating means may operatively be associated with both the tensioning means and a movable guide, the regulating means being adapted for moving the guide while at the same time moving the tensioning means towards its tensioned position.

More particularly, the self-adjusting regulating means may be adapted for continuously moving the guide and the tensioning means while the belt is running.

The self-adjusting regulating means may include at least one elongate regulating arm mechanically linking the tensioning means and the movable guide. The regulating arm may be characterised therein that it is adjustable in length.

In one form of the invention, the regulating arm may be a hydraulically operable arm associated In use with suitable pumping means. Particularly, the regulating arm may be an elongate telescopic arm pivotally connected at one end thereof to a rigid support and connected at an opposite end thereof to the tensioning means and the movable guide. The rigid support may suitably be dimensioned for at least partially accommodating the non-movable guide, the arrangement being such that the regulating arm may pivotally be connected at one end thereof to the tensioning means and the movable guide, while being releasably connected at the opposite end thereof to the substantially non-movable guide.

The self-adjusting regulating means also may include adjustment means for adjusting the regulating arm upon a decrease in belt tension. Particularly, the adjustment means may adjust the length of the telescopic arm so as to move the guides relative to each other. More particularly, the adjustment means may extend the length of the telescopic arm so as to move the guides away from each other to tension the belt as the same slackens in use.

The adjustment means may Include sensing means suitable for continuously sensing one or more operating parameters of the guide system. The sensing means operatively may be associated with at least one of the guides, and/or the tensioning means, and/or the belt.

The operating parameters may be characterised therein that a change in such a parameter is indicative either of a change in belt tension of the belt extending between the guides, or a change in load transfer efficiency between the guides. More particularly, in one form of the invention a change in an operating parameter may be indicative of a decrease in the belt tension. In another form of the invention, a change in an operating parameter may be indicative of slip of the belt on either of the driver or driven guides. The operating parameters so sensed may be selected from a group including, albeit not limited to, rotating shaft speed of one or both of the guides; shaft temperature of the driver guide; load change on the tensioning means; and displacement of the guide shafts relative to each other.

The adjustment means also may include electronic control means arranged in communication with the sensing means. The electronic control means may be adapted to receive signals being transmitted from the sensing means concerning one or more operating parameters and for comparing the same with a calculated set-point. The electronic control means also continuously may recalculate set-points for the system as operating parameters change. It will be appreciated that a particular set-point is a function of various operating parameters, such as rotation speeds of the guides and the distance between the guide shafts.

The adjustment means may be arranged in electronic communication with the regulating arm and its associated pumping means, the arrangement being such that the adjustment means electronically may self-adjust the length of the regulating arm proportionally to a decrease in belt tension.

The guide system may be a pulley system comprising at least two pulleys that are operatively associated with each other by means of the intermediately extending belt and arranged for transmitting mechanical power between the adjacent pulleys.

According to another aspect of the invention there is provided a method of continuously regulating belt tension of a belt extending between adjacent guides of a guide system, the method comprising the steps of providing an endless belt; providing at least two guides for guiding the belt; providing tensioning means that is movable between a tensioned and a substantially non-tensioned position, the arrangement being such that in the tensioned position it is biased to the non-tensioned position to compensate for a loss in belt tension; providing self-adjusting regulating means operatively associated with the tensioning means and being adapted for moving the tensioning means towards its tensioned position; and electronically effecting self-adjusting of the tensioning means upon occurrence of belt slacking so as to effect substantially immediate and continuous tensioning of the belt while the belt is running.

In one form of the invention, the belt may be tensioned through displacement of at least one guide relative to the other.

The tensioning means may be movable between a tensioned and a substantially non-tensioned position so that in the tensioned position it is biased to the non-tensioned position for moving the guides to tension the belt.

The self-adjusting regulating means may include at least one elongate regulating arm mechanically linking the tensioning means and the movable guide. The regulating arm may be characterised therein that it is adjustable in length. In one form of the invention, the regulating arm may be a hydraulically operable arm associated in use with suitable pumping means.

The self-adjusting regulating means also may include adjustment means for adjusting the regulating arm upon a decrease in belt tension. The adjustment means may include sensing means suitable for continuously sensing one or more operating parameters of the guide system. The operating parameters may be characterised therein that a change in such a parameter is indicative either of a change in belt tension of the belt extending between the guides, or a change in load transfer efficiency. More particularly, in one form of the invention a change in an operating parameter may be indicative of a decrease in the belt tension, while in another form of the Invention, such a change may be indicative of slip of the belt on either of the driver or driven guides. The operating parameters so sensed may be selected from a group Including, albeit not limited to, rotating shaft speed of one or both of the guides; shaft temperature of the driver guide; load change on the tensioning means; and displacement of the guide shafts relative to each other.

The method further may include the step of calculating at least one set-point for the system. It will be appreciated that the set-point is a function of various operating parameters of the system. More particularly, the method may include the step of continuously sensing one or more operating parameters of the guide system and moving the tensioning means upon sensing a difference between the operating parameters and the calculated set-point. The sensing means may be arranged in communication with the regulating arm, the arrangement being such that upon sensing a change between the operating parameters and the calculated set-point, the regulating arm moves the tensioning means towards its tensioned position while at the same time moving the movable guide, thus tensioning the belt proportionally to the decrease in belt tension.

The self-adjusting regulating means also may include electronic control means arranged in communication with the sensing means. The electronic control means may be adapted to receive signals being transmitted from the sensing means concerning one or more operating parameters, to compare the same with the calculated set-point, and electronically to self-adjust the regulating means upon sensing a change between the operating parameters and the set-point. The electronic control means also continuously may recalculate set-points for the system as the operating parameters change in use.

Accordingly, the method may include the step of continuously effecting electronic self-adjusting of the tensioning means and associated self-adjusting of the movable guide proportionally to and upon occurrence of a change between the operating parameters and the calculated set-point while the belt is running.

According to a further aspect of the invention there is provided a method of regulating belt tension of a belt extending between adjacent guides of a guide system, the method comprising the steps of providing an endless belt; providing at least two guides for guiding the belt; providing tensioning means for tensioning the belt between the guides; calculating at least one preferred operating set-point for the system, wherein the set-point is a function of at least one operating parameter of the system; providing sensing means for continuously sensing the operating parameter of the guide system; and tensioning the belt proportionally to a change between the sensed operating parameter and the calculated set-point.

The method may include the step of providing adjustment means operatively associated with the tensioning means and one or both of the guides, the arrangement being such that the adjustment means moves the tensioning means to its tensioned position while at the same time moving the guide so as to tension the belt upon occurrence of belt slacking.

The sensing means may be arranged for continuously sensing one or more operating parameters of the guide system. The sensing means operatively may be associated with at least one of the guides, and/or the tensioning means, and/or the belt. The sensing means also may be connected to the adjustment means.

The operating parameters may be characterised therein that a change in such a parameter is indicative either of a change in belt tension of the belt extending between the guides, or a change in load transfer efficiency between the guides. More particularly, in one form of the invention a change in an operating parameter may be indicative of a decrease in the belt tension. In another form of the invention, a change in an operating parameter may b indicative of slip of the belt on either of the driver or driven guides. The operating parameters so sensed may be selected from a group including, albeit not limited to, rotating shaft speed of one or both of the guides; shaft temperature of the driver guide; load change on the tensioning means; and displacement of the guide shafts relative to each other.

Accordingly, the method may include the step of continuously tensioning the tensioning means and moving the guides so as to tension the belt, and doing so proportionally to a change between the sensed operating parameters and the pre-calculated set-points while the belt is running.

The method further may include the step of providing electronic control means arranged in communication with the sensing means. The electronic control means may be adapted to receive signals being transmitted from the sensing means concerning one or more operating parameters and for comparing the same with a calculated set-point. It will be appreciated that a number of set-points may be calculated for a particular system. The electronic control means also continuously may recalculate set-points for the system as the operating parameters change.

The adjustment means may be arranged in communication with the electronic control means, the adjustment means being adapted electronically to move at least one guide relative to the other proportionally to a decrease in belt tension.

### SPECIFIC EMBODIMENT OF THE INVENTION

Without limiting the scope thereof, the invention will now be described by way of example only and with reference to the accompanying drawings wherein—

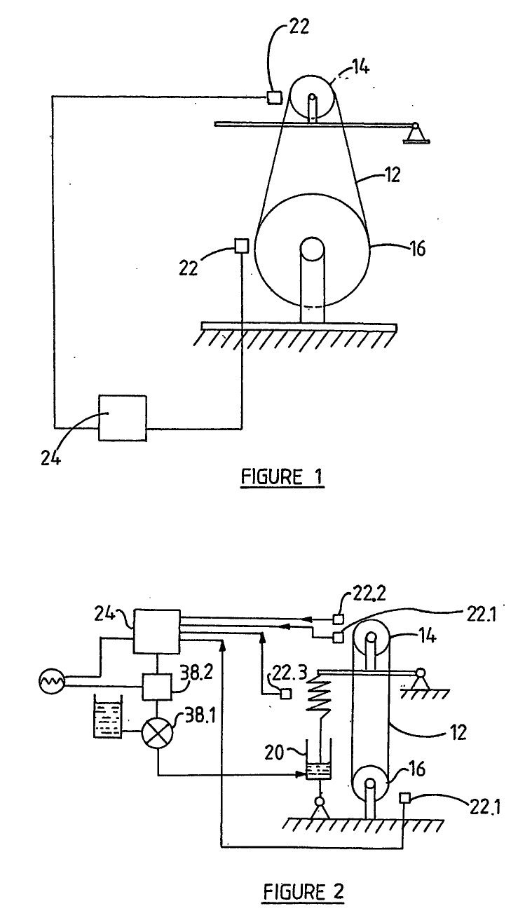

FIG. 1 is a diagrammatical illustration of a guide system according to one embodiment of the invention;

FIG. 2 is a diagrammatical illustration of a guide system according to another embodiment of the invention, wherein the guide system includes electronic control means;

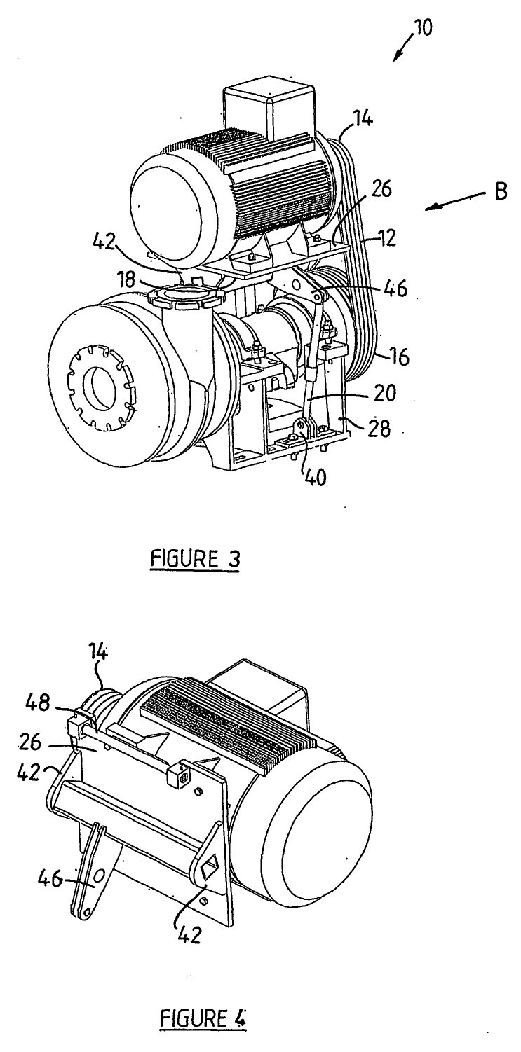

FIG. 3 is an perspective view of the guide system of the Invention;

FIG. 4 is a perspective view from below of a portion of the guide system of FIG. 3;

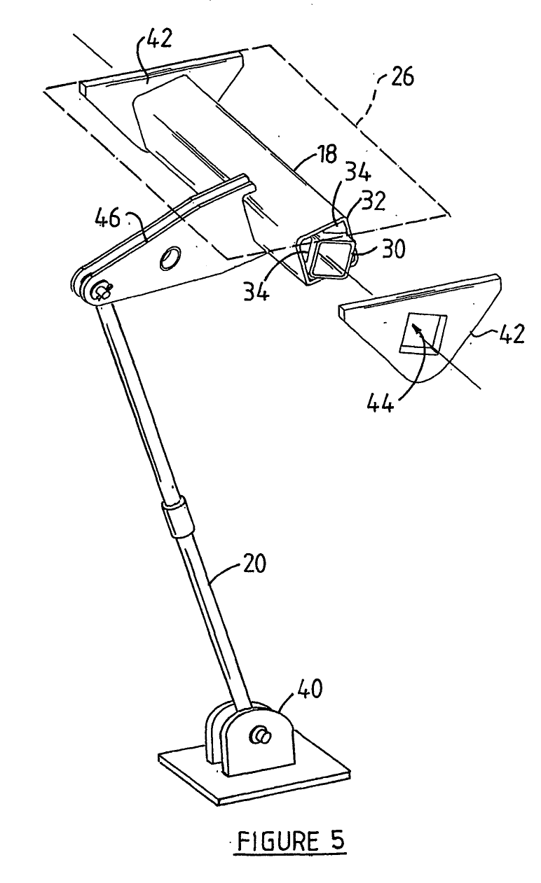

FIG. 5 is a perspective view of a tensioning means and regulating arm of the guide system of FIG. 3; and

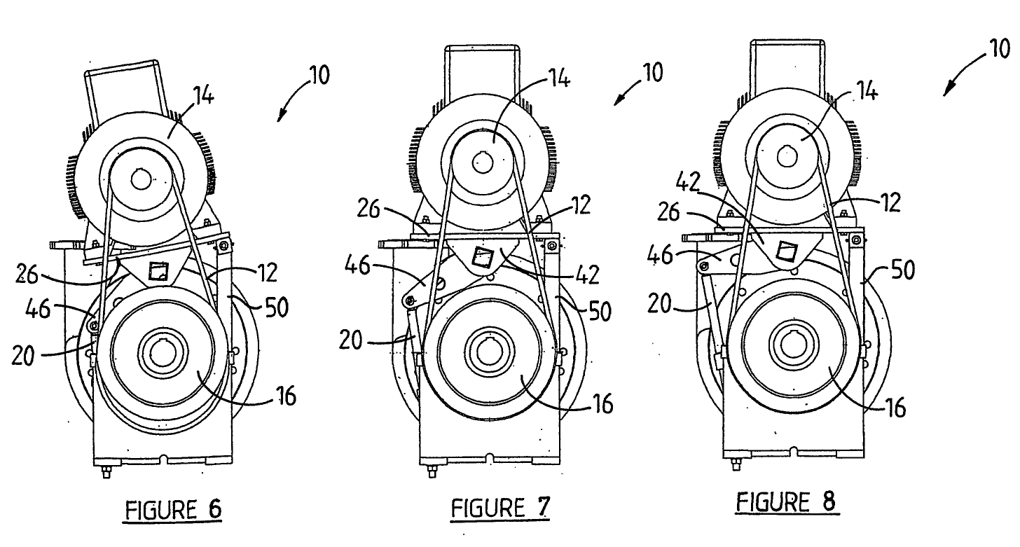

FIGS. 6 to 8 are side views, in the direction of arrow A of FIG. 3 of various operating positions of the guide system, illustrating working of the same.

A guide system according to the invention is generally designated by reference numeral 10. The guide system 10 comprises an endless belt 12 extending between two guides 14, 16 for guiding the belt 12. In the illustrated embodiment of the invention, the one guide 14 is movable relative to the other guide 16 in order to tension the belt 12, although it will be appreciated that both guides 14, 16 may be movable relative to each other.

The movable guide 14 is removably mounted on a base plate 26. The non-movable guide 16 is mounted to a support frame 28 that can be bolted to a floor, table or the like rigid support surface. Base plate 26 includes a rod 48 that is connected to a bottom face of base plate 26. Base plate 26 is also connected to the support frame 28 by means of a support post 50, the support post 50 being pivotally connected to a rod 48 so as to permit tilting of the base plate 26 relative to the support frame 28.

The guide system 10 also includes tensioning means 18. In the illustrated embodiment of the invention, the tensioning means 18 is in the form of resiliently flexible biasing means, and more specifically the tensioning means is a Neidhart unit 18. The Neidhart unit 18 comprises an elongate shaft 30 trapped within a concentrically orientated elongate sleeve 32, together with a number of resiliently flexible elements 34 located intermediate an outside of the shaft 30 and an interior face of the sleeve 32. The shaft 30 and the sleeve 32, which are generally of square cross-section, are longitudinally off-set relative to each other by approximately 45°, thus defining four elongate bores intermediate the shaft 30 and the sleeve 32. The resiliently flexible elements 34, which are generally elongate rubber elements, are located in these bores.

The tensioning means 18 is flexible between a tensioned position, as illustrated in FIG. 8, and a substantially non-tensioned position, as illustrated in FIG. 6. When the tensioning means 18 is in the tensioned position, the belt 12 is optimally tensioned between the guides 14, 16 and when the tensioning means 18 is in the substantially non-tensioned position, the belt 12 is non-optimally tensioned between the guides. In the tensioned position, the sleeve 32 is rotated about its longitudinal axis relative to the shaft 30 so that the elements 34 are substantially resiliently deformed. This creates rotational tension on the shaft 30 in an opposite direction, thus resiliently biasing the tensioning means 18 to the non-tensioned position.

The tensioning means 18 is connected to the base plate 26 of the movable guide 14 by means of connecting brackets 42 that are welded, or otherwise attached, to a bottom face of base plate 26. The connecting brackets 42 include locating apertures 44 complimentarily dimensioned for receiving shaft 30 therein, thus connected the tensioning means 18 to the base plate 26 of the guide 14.

The guide system 10 further includes self-adjusting regulating means for moving the guide 14 while at the same time flexing the tensioning means 18 towards its tensioned position. In particular, the regulating means includes an elongate regulating arm 20 for mechanically linking the tensioning means 18 and the movable guide 14 to each other. The regulating arm 20 is an hydraulically operable telescopic arm that is adjustable in length. The regulating arm 20 is pivotally connected at one end thereof to the rigid support 28 by means of a support bracket 40.

At an opposite end thereof the regulating arm 20 is connected to the tensioning means 18 and the movable guide 14. Particularly, the regulating arm 20 is pivotally connected to the sleeve 32 of tensioning means 18 by intermediate bracket arm 46. Bracket arm 46 extends from the regulating arm 20 to the tensioning means 18 where it is welded to sleeve 32.

The regulating arm 20 is arranged in communication with a suitable pumping means 38. The pumping means 38 includes a 50W, 12V DC motorised pump 38.1 and a 50W, 12V relay 38.2 for driving the pump.

The regulating means also includes adjustment means for adjusting the regulating arm 20 proportionally to a decrease In belt tension of the belt 12 extending between the guides 14, 16. Particularly, the adjustment means is adapted to extend the length of the telescopic arm 20 so as to move guide 14 away from guide 16 to tension the belt 12 as the same stretches in use.

The adjustment means Includes sensing means 22 suitable for continuously sensing one or more operating parameters of the guide system 10 while the belt is running. The operating parameters sensed are characterised therein that a change in such a parameter is indicative either of a change in belt tension of the belt 12 extending between the guides 14, 16, or a change in load transfer efficiency between the driver guide 14 and the driven guide 16.

The sensing means 22 includes sensors 22.1 for sensing respective rotating shaft speeds of the guides 14, 16; sensors 22.2 for sensing shaft heat temperatures of one or more of the guides; sensors 22.3, such as laser sensors, for sensing displacement of the guide shafts relative to each other; sensors (not shown) for sensing load change on the tensioning means 18 (i.e. orientation of shaft 30 relative to sleeve 32 of the tensioning means 18); or the like.

The adjustment means of the guide system illustrated in FIG. 2 further includes electronic control means 24 arranged in electronic communication with the sensing means 22. The electronic control means 24 is adapted to receive signals from the sensing means 22 concerning one or more operating parameters and for comparing the same with a calculated set-point of the system 10. Particularly, the adjustment means is arranged in electronic communication with the regulating arm 20 and its associated pumping means 38, the arrangement being such that the adjustment means electronically self-adjusts the length of the regulating arm 20 substantially immediately upon occurrence of belt slacking.

Reference is now made particularly to FIGS. 5 to 8. In use, regulating arm 20 is initially retracted to a position illustrated in FIG. 6 so as to fit belt 12 over guides 14 and 16. When the regulating arm 20 is in the retracted position, base plate 26 is tilted relative to support frame 28 so as to bring guide 14 closer to guide 16. Once the belt 12 is fitted, regulating arm 20 is extended (FIG. 7) so as to back-tilt base plate 26 and to move guide 14 away from guide 16, until the belt 12 is taut between the guides. Regulating arm 20 is then extended even further (FIG. 8) to effect pre-tensioning of the belt 12 by rotating shaft 30 relative to sleeve 32 to effect resilient deformation of the elongate members 34.

In use, the sensing means 22 continuously senses one or more operating parameters of the guide system 10, such as respective rotating shaft speeds of the guides 14, 16; shaft heat temperatures of one or more of the guides; load change on the tensioning means 18; distance between the shafts of guides 14 and 16; or the like. Such sensed values are transmitted to the electronic control means 24, which constantly monitors the system by comparing the sensed value for a particular operating parameter with the calculated set-point for such a parameter, and by recalculating set-points for the system as operating parameters change.

As the belt 12 slackens in use, a change is sensed in the operating parameters, upon which indicating means (not shown) indicate to a plant operator that pre-tensioning of the belt 12 is required. The belt 12 can then be tensioned manually by the plant operator.

Alternatively, the electronic control means 24 electronically actuates pumping means 38 for effecting hydraulic extension of regulating arm 20. Regulating arm 20 rotates sleeve 32 relative to shaft 30 for tensioning the tensioning means 18, while at the same time moving guide 14 relative to guide 16, thereby tensioning belt 12.

The applicant believes that belt tension of the belt 12 extending between the guides 14, 16 is correlated to the efficiency with which mechanical power is transmitted between the guides 14, 16; to the efficiency with which the driven guide 14 operates (e.g. pump output); to the life span of the belt 12; and hence to the efficiency with which a mechanical power transmission system operates as a whole over a period of time. Accordingly, by monitoring, controlling and regulating belt tension, operating efficiency of the mechanical power transmission system, for example machine availability, can be improved.

It will be appreciated that various other embodiments of the invention may be possible without departing from the spirit or scope of the invention as set out In the claims.

1. A guide system [10] comprising an endless belt [12]; at least two guides [14,16] for guiding the belt [12]; tensioning means [18] for tensioning the belt [12] between the guides [14,16], the tensioning means [18] being movable between a tensioned and a substantially non-tensioned position, the arrangement being such that in the tensioned position it is biased to the non-tensioned position to compensate for a loss in belt tension; and self-adjusting regulating means operatively associated with the tensioning means [18] and being adapted for moving the tensioning means [18] towards its tensioned position upon occurrence of belt slacking for effecting substantially immediate tensioning of the belt [12].

2. The guide system [10] according to claim 1 characterised therein that the belt [12] is tensioned through displacement of at least one guide relative to the other, and in particular through displacement of the movable guide [14] away from the other, substantially non-movable guide [16] so as to increase distance between the respective guides [14,16].

3. The guide system [10] according to claim 1 characterised therein that both guides [14,16] are movable relative to and away from each other for tensioning the belt [12].

4. The guide system [10] according to claim 1 characterised therein that the tensioning means [18] is movable between a tensioned and a substantially non-tensioned position such that in the tensioned position it is biased to the non-tensioned position for moving the guides [14,16], the arrangement being such that when the tensioning means [18] is In the tensioned position, the belt [12] is optimally tensioned between the guides [14,16], and when the tensioning means [18] is in the substantially non-tensioned position, the belt [12] is non-optimally tensioned between the guides [14,16].

5. The guide system [10] according to claim 4 characterised therein that the tensioning means [18] is a conventional belt tensioner.

6. The guide system [10] according to claim 4 characterised therein that the tensioning means [18] is resilient biasing means that is flexible between a tensioned and substantially non-tensioned position.

7. The guide system [10] according to claim 6 characterised therein that the resiliently flexible biasing means is any suitable spring, torsion element or the like, such as a Neidhart unit.

8. The guide system [10] according to claim 4 characterised therein that the tensioning means [18] is other mechanical tensioning means selected from a group including, although not limited to, a screw thread mechanism, at least one hydraulic tensioning arm, a worm gear arrangement or the like.

9. The guide system [10] according to claim 1 characterised therein that the self-adjusting regulating means is operatively associated with both the tensioning means [18] and a movable guide, the regulating means being adapted for moving the guide while at the same time moving the tensioning means [18] towards Its tensioned position.

10. The guide system [10] according to claim 9 characterised therein that the self-adjusting regulating means is adapted for continuously moving the guide [14] and the tensioning means [18] while the belt [12] is running.

11. The guide system [10] according to claims 1, 9 and 10 characterised therein that the self-adjusting regulating means includes at least one elongate regulating arm [20] mechanically linking the tensioning means [18] and the movable guide [14].

12. The guide system [10] according to claim 11 characterised therein that the regulating arm [20] is adjustable in length.

13. The guide system [10] according to claims 11 and 12 characterised therein that the regulating arm [20] is a hydraulically operable arm associated in use with suitable pumping means [38].

14. The guide system [10] according to claim 13 characterised therein that the regulating arm [20] is an elongate telescopic arm pivotally connected at one end thereof to a rigid support [28] and connected at an opposite end thereof to the tensioning means [18] and the movable guide [14].

15. The guide system [10] according to claim 14 characterised therein that the rigid support [28] is suitably dimensioned for at least partially accommodating the non-movable guide [16], the arrangement being such that the regulating arm [20] is pivotally connected at one end thereof to the tensioning means [18] and the movable guide [14], while being releasably connected at the opposite end thereof to the substantially non-movable guide [16].

16. The guide system [10] according to claims 1 and 9 characterised therein that the self-adjusting regulating means also includes adjustment means for adjusting the regulating arm [20] upon a decrease in belt [12] tension.

17. The guide system [10] according to claim 16 characterised therein that the adjustment means adjusts the length of the telescopic arm so as to move the guides [14,16] relative to each other, and particularly extends the length of the telescopic arm so as to move the guides [14,16] away from each other to tension the belt [12] as the same slackens in use.

18. The guide system [10] according to claim 16 characterised therein that the adjustment means includes sensing means [22] suitable for continuously sensing one or more operating parameters of the guide system [10].

19. The guide system [10] according to claim 18 characterised therein that the sensing means [22] is operatively associated with at least one of the guides [14,16], and/or the tensioning means [18], and/or the belt [12].

20. The guide system [10] according to claim 18 characterised therein that the operating parameters are characterised therein that a change in such a parameter is indicative either of a change in belt tension of the belt [12] extending between the guides [14,16], or a change in load transfer efficiency between the guides [14,16], and particularly a change in an operating parameter is indicative either of a decrease in the belt tension, or of slip of the belt [12] on either of the driver or driven guides [14,16].

21. The guide system [10] according to claims 18 or 20 characterised therein that the operating parameters so sensed are selected from a group including, albeit not limited to, rotating shaft speed of one or both of the guides [14,16]; shaft temperature of the driver guide; load change on the tensioning means [18]; and displacement of the guide shafts relative to each other.

22. The guide system [10] according to claim 16 characterised therein that the adjustment means also includes electronic control means [24] arranged in communication with the sensing means [22], the electronic control means [24] being adapted to receive signals being transmitted from the sensing means [22] concerning one or more operating parameters and for comparing the same with a calculated set-point.

23. The guide system [10] according to claim 22 characterised therein that the electronic control means [24] continuously recalculates set-points for the system as operating parameters change.

24. The guide system [10] according to claims 11 and 16 characterised therein that the adjustment means is arranged in electronic communication with the regulating arm [20] and its associated pumping means [38], the arrangement being such that the adjustment means electronically self-adjusts the length of the regulating arm [20] proportionally to a decrease in belt [12] tension.

25. A method of continuously regulating belt tension of a belt [12] extending between adjacent guides [14,16] of a guide system [10], the method comprising the steps of providing an endless belt [12]; providing at least two guides [14,16] for guiding the belt [12]; providing tensioning means [18] that is movable between a tensioned and a substantially non-tensioned position, the arrangement being such that in the tensioned position it is biased to the non-tensioned position to compensate for a loss in belt [12] tension; providing self-adjusting regulating means operatively associated with the tensioning means [18] and being adapted for moving the tensioning means [18] towards its tensioned position; and electronically effecting self-adjusting of the tensioning means [18] upon occurrence of belt slacking so as to effect substantially immediate and continuous tensioning of the belt [12] while the belt [12] is running.

26. The method according to claim 25 characterised therein that the belt [12] is tensioned through displacement of at least one guide relative to the other.

27. The method according to claim 25 characterised therein that the tensioning means [18] is movable between a tensioned and a substantially non-tensioned position so that in the tensioned position it is biased to the non-tensioned position for moving the guides [14,16] to tension the belt [12].

28. The method according to claim 25 characterised therein that the method includes the step of providing at least one elongate regulating arm [20] for mechanically linking the tensioning means [18] and the movable guide, the regulating arm [20] being characterised therein that it is adjustable in length.

29. The method according to claim 28 characterised therein that the method includes providing adjustment means for adjusting the regulating arm [20] upon a decrease in belt tension.

30. The method according to claim 25 characterised therein that the method further includes providing sensing means [22] suitable for continuously sensing one or more operating parameters of the guide system [10], wherein the operating parameters are characterised therein that a change in such a parameter is indicative either of a change in belt tension of the belt [12] extending between the guides [14,16], or a change in load transfer efficiency, and particularly, a change in an operating parameter is indicative either of a decrease in the belt tension, or of slip of the belt [12] on either of the driver or driven guides [14,16].

31. The method according to claim 25 characterised therein that the method further includes the step of calculating at least one set-point for the system, wherein the set-point is a function of various operating parameters of the system.

32. The method according to claim 31 characterised therein that the method includes the step of continuously sensing one or more operating parameters of the guide system [10] and moving the tensioning means [18] upon sensing a difference between the sensed operating parameters and the pre-calculated set-point.

33. The method according to claims 28, 31 and 32 characterised therein that the method includes arranging the sensing means [22] in communication with the regulating arm [20] such that upon the sensing means [22] sensing a change between the operating parameters and the calculated set-point, the regulating arm [20] moves the tensioning means [18], towards its tensioned position while at the same time moving the movable guide, thus tensioning the belt [12] proportionally to the decrease in belt [12] tension.

34. The method according to claim 25 characterised therein that the method includes the further step of providing electronic control means [24] arranged in communication with the sensing means [22], wherein the electronic control means [24] is adapted to receive signals being transmitted from the sensing means [22] concerning one or more operating parameters, to compare the same with the calculated set-point, and electronically to self-adjust the regulating means upon sensing a change between the operating parameters and the set-point.

35. The method according to claim 34 characterised therein that the method further provides that the electronic control means [24] continuously recalculates set-points for the system as the operating parameters change in use.

36. The method according to claim 25 characterised therein that the method includes the step of continuously effecting electronic self-adjusting of the tensioning means [18] and associated self-adjusting of the movable guide proportionally to and upon occurrence of a change between the operating parameters and the calculated set-point while the belt [12] is running.

37. A method of regulating belt tension of a belt [12] extending between adjacent guides [14,16] of a guide system [10], the method comprising the steps of providing an endless belt [12]; providing at least two guides [14,16] for guiding the belt [12]; providing tensioning means [18] for tensioning the belt [12] between the guides [14,16]; calculating at least one preferred operating set-point for the system, wherein the set-point is a function of at least one operating parameter of the system; providing sensing means [22] for continuously sensing the operating parameter of the guide system [10]; and tensioning the belt [12] proportionally to a change between the sensed operating parameter and the calculated set-point.

38. The method according to claim 37 characterised therein that the method includes the step of providing adjustment means operatively associated with the tensioning means [18] and one or both of the guides [14,16], the arrangement being such that the adjustment means moves the tensioning means [18] to its tensioned position while at the same time moving the guide so as to tension the belt [12] upon occurrence of belt slacking.

39. The method according to claim 37 characterised therein that the sensing means [22] are operatively associated with at least one of the guides [14,16], and/or the tensioning means [18], and/or the belt [12] arranged such that it continuously senses one or more operating parameters of the guide system [10].

40. The method according to claim 37 characterised therein that the sensing means [22] are also connected to the adjustment means.

41. The method according to claim 37 characterised therein that the method includes the step of continuously tensioning the tensioning means [18] and moving the guides [14,16] so as to tension the belt [12], and doing so proportionally to a change between the sensed operating parameters and the pre-calculated set-points while the belt [12] is running.

42. The method according to claim 37 characterised therein that the method includes the further step of providing electronic control means [24] arranged in communication with the sensing means [22] wherein the electronic control means [24] is adapted to receive signals being transmitted from the sensing means [22] concerning one or more operating parameters and for comparing the same with a calculated set-point.

43. The method according to claim 42 characterised therein that a number of set-points are calculated for a particular system and in particular, the electronic control means [24] continuously recalculates set-points for the system as the operating parameters change.
